(19) United States
(12) Patent Application Publication
(10) Pub. No.: US 2010/0185425 A1
(43) Pub. Date: Jul. 22, 2010

(54) Performing Molecular Dynamics Simulation on a Multiprocessor System

(75) Inventors: Guang Lei Li, Beijing (CN); Bai Ling Wang, Beijing (CN); Xin Zhong, Beijing (CN); Wen Jun Wang, Beijing (CN)

Correspondence Address: Greg Goshorn, P.C., 9600 Escarpment, Suite 745-9, AUSTIN, TX, 78749, US

(73) Assignee: INTERNATIONAL BUSINESS MACHINES CORPORATION, Armonk, NY (US)

(21) Appl. No.: 12/686,416

(22) Filed: Jan. 13, 2010

(30) Foreign Application Priority Data
Jan. 21, 2009 (CN) 200910003257.1

(51) Int. Cl. G06G 7/48; G06F 7/60

(52) U.S. Cl. 703/6

(57) ABSTRACT

The present invention provides techniques for performing molecular dynamics simulation on a multiprocessor system. The method comprises: dividing a substance space on which molecular dynamics simulation are to be performed into a plurality of cells; storing data of molecules of the plurality of cells in the main memory of the multiprocessor system such that data of molecules of each cell are continuously stored in a memory area corresponding to the cell; and the plurality of accelerators repeatedly acquiring the data of molecules of the plurality of cells from the main memory and performing molecular dynamics simulation computations in parallel such that data of molecules of at least one cell are acquired in one DMA operation. By continuously storing data of molecules of each cell in a memory area corresponding to the cell, the present invention reduces the data exchanges between each accelerator and the main memory during simulation.

### BACKGROUND

Molecular dynamics simulation means to simulate the motion process of molecules by using a computer. As an important HPC (High Performance Computing) application, it is often adopted in investigating the properties of substances. By utilizing molecular dynamics simulation in a computer to trace the characteristics of motion of all molecules, the overall properties of substance can be derived, whereby matters at the molecular level can be dealt with. This is of practical significance in research fields of material, biology, optics, medical science, and the like.

In order to obtain the motion trajectories of molecules in molecular dynamics simulation, the motion of all the molecules needs to be traced at every moment. Accordingly, there exist a large number of iterative simulation computation steps. In molecular dynamics simulation, during each iterative step, properties such as force, acceleration, velocity, position, etc. of each molecule that are capable of indicating the current state of the molecule need to be calculated, respectively.

It can be appreciated that computationally, molecular dynamics simulation is a very huge task, since there will be a large number of molecules to be simulated and a large number of simulation steps to be performed.

In molecular dynamics simulation, the vast majority of calculation time is spent on calculating the acting forces of molecular pairs, since when calculation of acting force between molecules is performed on a specific molecule, all the surrounding adjacent molecules of the specific molecule need to be taken into account, i.e. acting forces between these surrounding adjacent molecules and the specific molecule need to be calculated, respectively, and then, operations such as summation, etc. are performed on these acting forces.

In existing solutions of molecular dynamics simulation, as is often the case, the whole substance space on which molecular dynamics simulation needs to be performed is divided into M×M×M cubic cells or cuboid cells in the space coordinates system, so as to facilitate finding the adjacent molecules based thereon. That is, each molecule belongs to a specific cell depending on its position. The description is given hereinafter by taking M×M×M cubic cells as an example, however, the person skilled in the art can appreciate that the case of cuboid cells is similar. As to M×M×M cubic cells, the length of each edge of each cell is equal to a cut-off radius, which is a predetermined value. If the distance between two molecules is larger than the cut-off radius, the acting force between the two molecules will be ignored. In this manner, calculation of acting force between molecules can be made convenient.

More specifically, FIG. 1 is an illustration of a conventional solution of molecular dynamics simulation 100. As shown in FIG. 1, in the conventional solution of molecular dynamics simulation 100, when the acting force of a specific molecule in a central cell 102 (represented in grey color) is calculated, the 26 (9 above the central cell, 9 below the central cell, and besides these above and below the central cell, 8 located at the lateral side of the central cell) cells (none of them were filled with colors) surrounding the central cell and the central cell itself, in total 27 cells, need to be taken into account, so as to find all the adjacent molecules whose distances from the specific molecule are within the cut-off radius, and calculate the sum of the acting forces between the respective adjacent molecules and the specific molecule, i.e. the following is taken into account in the conventional solution:

27 cells=26 surrounding adjacent cells+the central cell 102 itself.

At present, there exists a plurality of different algorithms for optimizing the calculation of acting force between molecules, among which the linkcell method has the best performance. In the linkcell method, according to Newton's third law, i.e. force_{a->b}=−force_{b->a,} it is considered that the acting force between two molecules is calculated only once. Based on such consideration, in the linkcell method, when the acting force of a specific molecule is calculated, the amount of calculation can be reduced almost by half by looking for only 14 cells, instead of all the 27 cells in the conventional solution, i.e. the following is taken into account in the linkcell method:

14 cells=13 surrounding adjacent cells+the central cell 102 itself.

More specifically, FIG. 2 is an illustration of the linkcell method 120. As shown in FIG. 2, in the linkcell method 120, when the acting force of a specific molecule in a central cell 124 (represented in dark grey color) is calculated, molecules in the 13 (9 cells 126 above central cell 124, and 4 cells 128 located at the lateral side of central cell 124) cells (represented in light grey color) need to be taken into account.

However, the above existing solutions of molecular dynamics simulation are all implemented on a platform of a single processor system, and implementation on such a platform yields less than ideal simulation performance.

The Cell Broadband Engine (CBE) is a single-chip multiprocessor system. As shown in FIG. 3, a CBE system 130 has nine processing units 141-148 and 171 operating on a shared, coherent main memory 180, these processing units 141-148 and 171 comprise one Power Processing unit (PPU) 171 and eight Synergistic Processing Units (SPU) 141-148, wherein each SPU has a 256-KB local storage 161-168, a Memory flow controller (MFC) 151-158 and relies on DMA (Direct Memory Access) operations to perform data transfer between its local storage 161-168 and the main memory 180. PPU 171 also includes a memory control unit 172 and a local storage, or L2, 173. Under such system architecture, CBE 130 is capable of providing outstanding computation capabilities. More specifically, Cell processor 130 is capable of achieving a computation capability of 204 Gflops/sec 132 under a clock frequency of 3.2 GHz. With such a high computation capability, apparently CBE 130 is an ideal platform for performing molecular dynamics simulation, in which large amounts of computation is involved.

### SUMMARY OF THE INVENTION

As the Inventors herein have recognized, if the above existing solutions of molecular dynamics simulation are directly applied to a multiprocessor system such as CBE 130, the performance will not be enhanced greatly. The reason is as follows.

In the existing solutions of molecular dynamics simulation, data of molecules of each cell are discretely stored in the memory, and the discretely stored data of molecules in a cell are concatenated together by means of a linked list. That is, each cell has a linked list corresponding thereto, which comprises pointers pointing to storage location of data of all the molecules within the cell. In addition, a global array is utilized to store headers of all the linked lists.

Moreover, in the existing solutions of molecular dynamics simulation, considering that molecules are in constant motion, and one molecule may move from one cell to another cell or even beyond the adjacent cell(s), the subordination relationship between the molecules and the cells is therefore adjusted after each iterative computation step. This adjustment is realized by adjusting the linked list. More specifically, the storage location of data of the molecules is kept unchanged, and by adjusting the linked list, data of the molecules whose subordination relationship with the cell has changed are removed from the linked list of the original cell, and linked to the linked lists of the cells into which the molecules have newly moved, so as to reflect the position change of the molecules in the simulated substance space.

Suppose that the above solutions are applied to CBE 130. When each SPU 141-148 acquires data of molecules of a required cell from main memory 180 of CBE 130 into its local storage 161-168, so as to perform simulation computations such as calculation of acting force between molecules, due to the fact that storage locations 161-168 of the data of molecules within the cell in the main memory 180 are discrete, it is necessary to utilize the linked list corresponding to the cell to position in turn the storage location of data of each molecule within the cell, and utilize in turn DMA operations to acquire these data of molecules into its local storage 161-168. In this manner, since the data of molecules are discretely stored, a DMA operation needs to be performed each time the data of a molecule is acquired, i.e. only one molecule can be acquired the data in one DMA operation. Accordingly, in order to acquire data of molecules of the required cell, each SPU 151-158 needs to utilize DMA operations to repeatedly perform data exchange between itself and main memory 180, which leads to a sharp decrease in the simulation performance.

Therefore, it is necessary to design a solution of molecular dynamics simulation, which is suitable for multiprocessor systems such as the CBE 130. The present invention relates to the data processing field, and more specifically, to a method and an apparatus for performing molecular dynamics simulation on a multiprocessor system.

In view of the above problem, the present invention provides a method and an apparatus for performing molecular dynamics simulation on a multiprocessor system which, by continuously storing data of molecules of each cell in the simulated substance space in a memory area corresponding to the cell, enables each accelerator in the multiprocessor system to utilize less DMA operations to acquire data of molecules of a plurality of cells from the main memory into its local storage, whereby reducing the frequent data exchanges between the accelerator and the main memory, and enhancing the simulation performance.

According to one aspect of the invention, there is provided a method for performing molecular dynamics simulation on a multiprocessor system, wherein the multiprocessor system comprises at least one core processor and a plurality of accelerators, the method comprising: dividing a substance space on which molecular dynamics simulation are to be performed into a plurality of cells; storing data of molecules of the plurality of cells in the main memory of the multiprocessor system in the manner in which data of molecules of each cell are continuously stored in a memory area corresponding to the cell; and the plurality of accelerators repeatedly acquiring the data of molecules of the plurality of cells from the main memory and performing molecular dynamics simulation computations in parallel in the manner in which data of molecules of at least one cell are acquired in one DMA operation.

According to another aspect of the invention, there is provided an apparatus for performing molecular dynamics simulation in a multiprocessor system, wherein the multiprocessor system comprises at least one core processor and a plurality of accelerators, the apparatus comprising: a cell dividing unit for dividing a substance space on which molecular dynamics simulation are to be performed into a plurality of cells; a molecular data storing unit for storing data of molecules of the plurality of cells in the main memory of the multiprocessor system in the manner in which data of molecules of each cell are continuously stored in a memory area corresponding to the cell; and a simulation unit for enabling the plurality of accelerators to repeatedly acquire the data of molecules of the plurality of cells from the main memory and perform molecular dynamics simulation computations in parallel in the manner in which data of molecules of at least one cell are acquired in one DMA operation.

### BRIEF DESCRIPTION OF THE DRAWINGS

It is believed that the features, advantages, and objectives of the present invention will be better understood from the following detailed description of the embodiments of the present invention, taken in conjunction with the drawings.

FIG. 1 is an illustration of a conventional solution of molecular dynamics simulation.

FIG. 2 is an illustration of the linkcell method.

FIG. 3 is a block diagram of the CBE system.

FIG. 4 is a flowchart of a method for performing molecular dynamics simulation on a multiprocessor system according to an embodiment of the present invention.

FIG. 5 is a detailed flowchart of the element of storing data of molecules in FIG. 4.

FIG. 6 is a detailed flowchart of the element 415 of acquiring data of molecules and performing molecular dynamics simulation computation in FIG. 4.

FIGS. 7 and 8 are illustrations of the process as shown in FIG. 6.

FIG. 9 is a detailed flowchart of the element 615 of acquiring data of molecules and performing molecular dynamics simulation layer-by-layer in FIG. 4.

FIG. 10-12 are illustrations of the process as shown in FIG. 9.

FIG. 13 is a block diagram of the apparatus for performing molecular dynamics simulation in a multiprocessor system according to an embodiment of the present invention.

### DETAILED DESCRIPTION OF THE INVENTION

Next, a detailed description of the preferred embodiments of the present invention will be given with reference to the drawings.

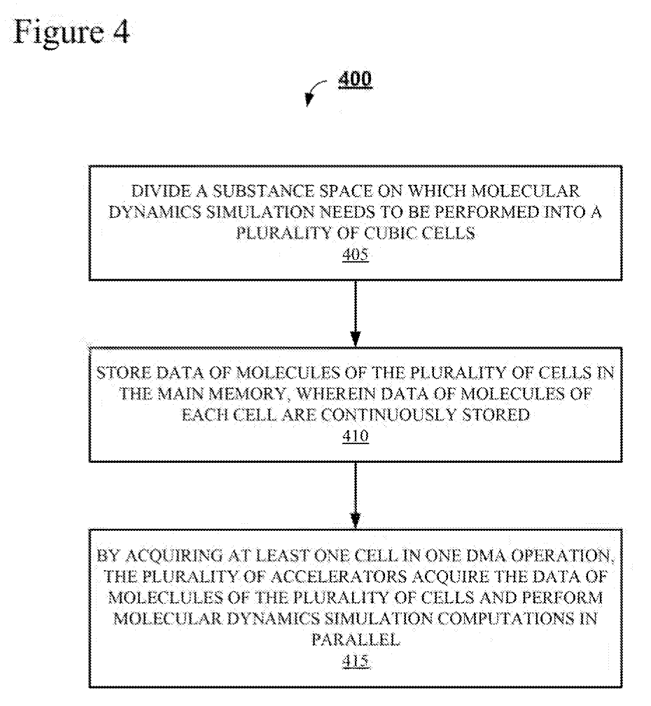

FIG. 4 is a flowchart 400 of a method for performing molecular dynamics simulation on a multiprocessor system according to an embodiment of the present invention, wherein, the multiprocessor system comprises at least one core processor and a plurality of accelerators. More specifically, the multiprocessor system may be, for example, the abovementioned CBE 130 that has one PPU (core processor) 171 and eight SPUs (accelerators) 141-148.

The method for performing molecular dynamics simulation on a multiprocessor system according to the present embodiment differs from the manner of the abovementioned existing solutions of molecular dynamics simulation, in which data of molecules of each cell are discretely stored and concatenated together by means of a linked list. The method of the present embodiment adopts a manner in which data of molecules within each cell of the substance space on which molecular dynamics simulation is to be performed are continuously stored in the memory area corresponding to the cell, respectively, in the main memory of the multiprocessor system.

The description is given hereinafter by taking M×M×M cubic cells as an example, however, the person skilled in the art can appreciate that the case of cuboid cells is similar.

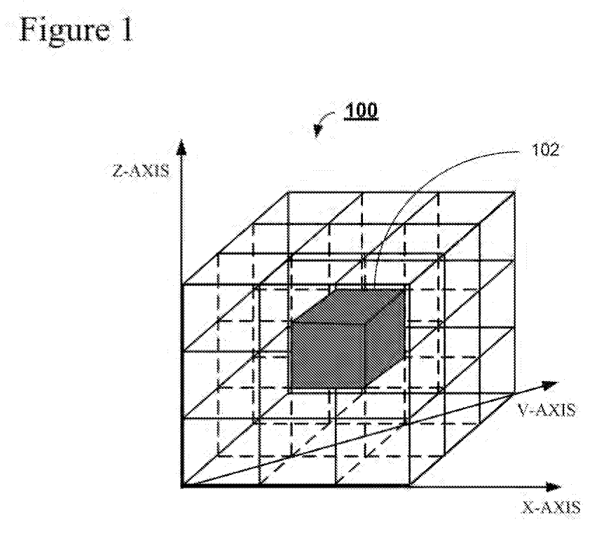

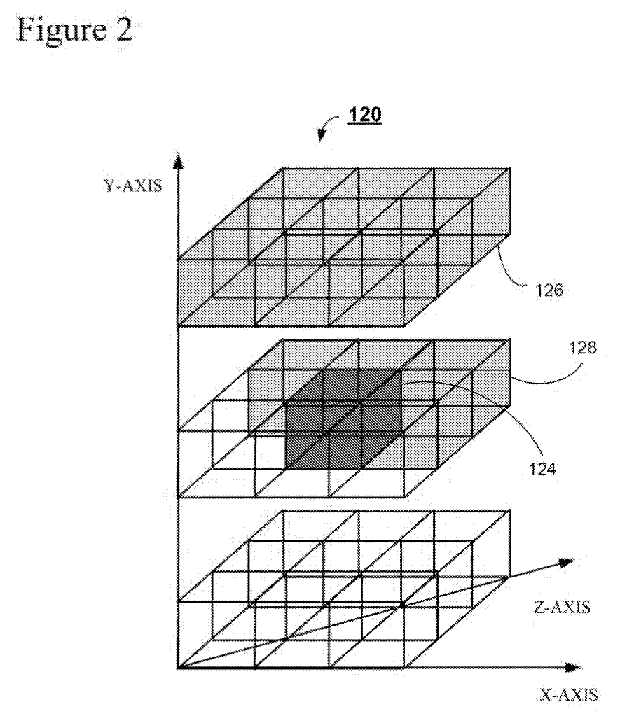

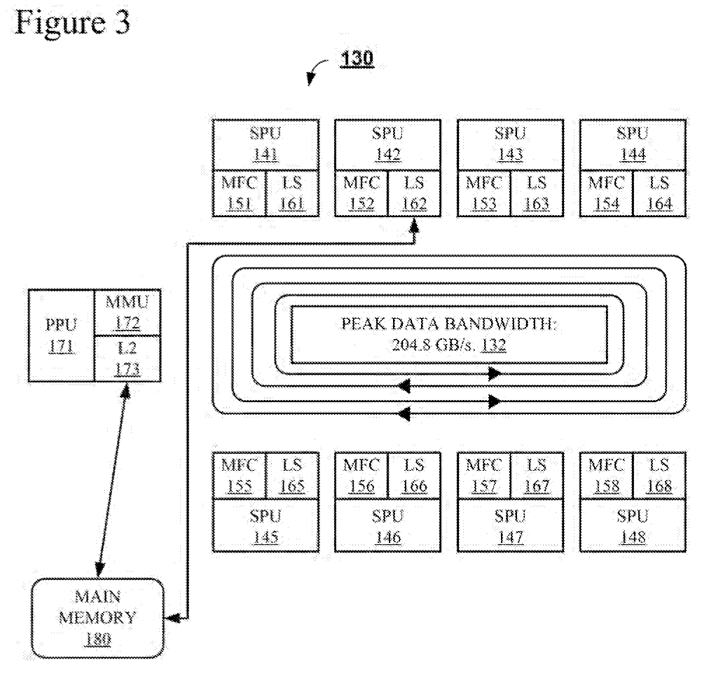

More specifically, as shown in FIG. 4, first at block 405, a method for performing molecular dynamics simulation on a multiprocessor system of the present embodiment divides a substance space on which molecular dynamics simulation needs to be performed into a plurality of, such as M×M×M, cubic cells, wherein, the length of each edge of each of the plurality of cubic cells is equal to a predetermined cut-off radius. This block is the same as the existing solutions described above with reference to FIGS. 1 and 2.

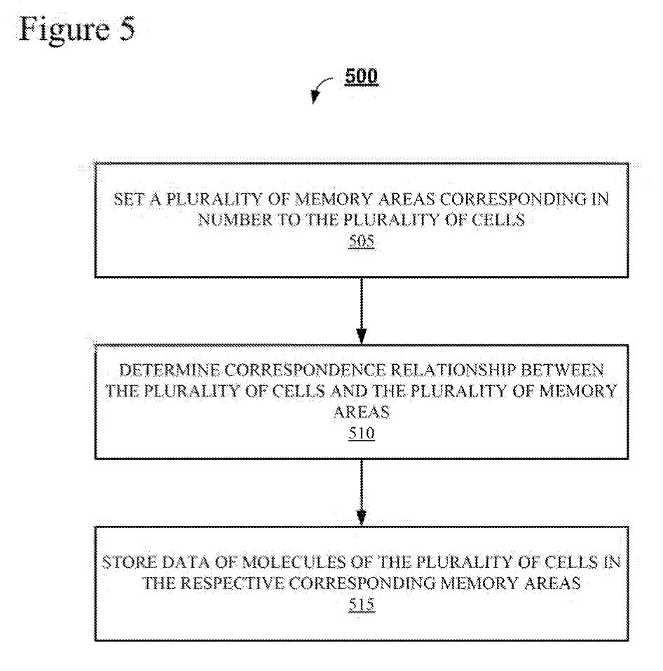

At block 410, data of molecules of the plurality of cells are stored in the main memory of the multiprocessor system in the manner that data of molecules of each cell are continuously stored in a memory area corresponding to this cell. As to this block, a detailed description will be given later with reference to FIG. 5.

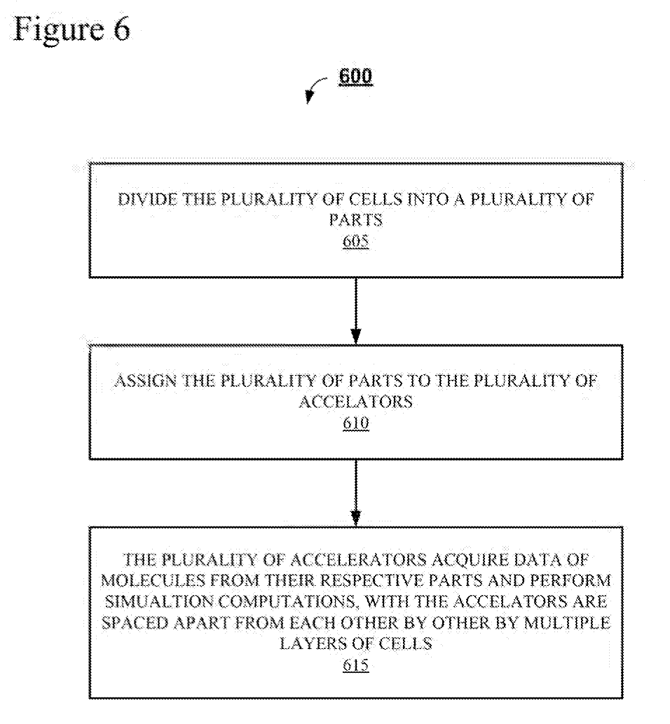

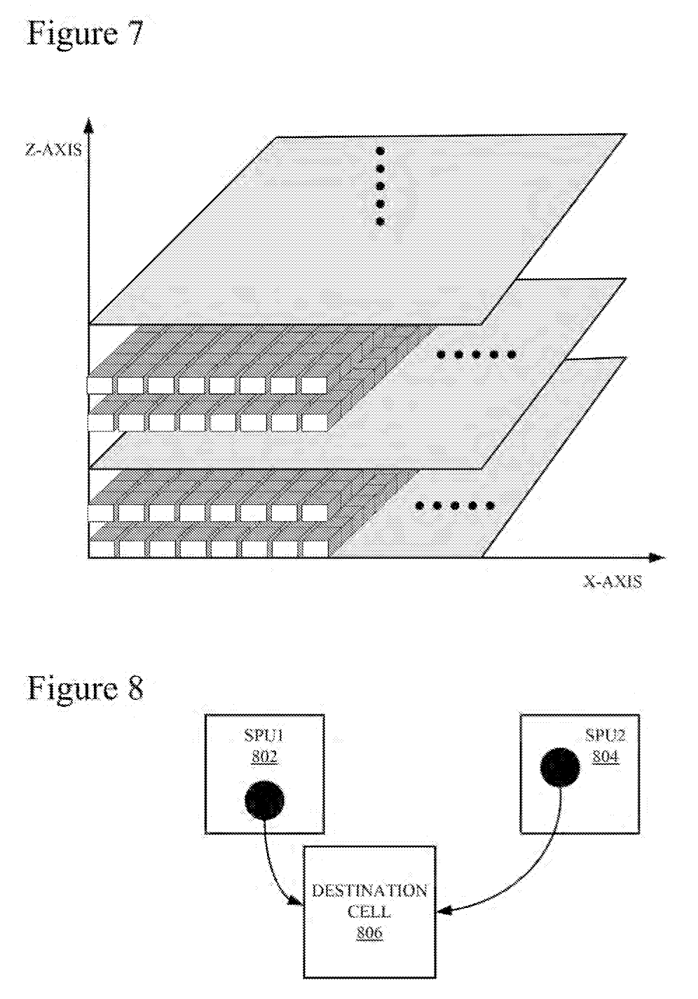

At block 415, the plurality of accelerators repeatedly acquire the data of molecules of the plurality of cells from the main memory and perform molecular dynamics simulation computations in parallel in the manner that data of molecules of at least one cell are acquired in one DMA operation. As to this block, a detailed description will be given later with reference to FIGS. 6 and 7.

Next, the block 410 of storing the data of molecules in FIG. 4 is described in detail with reference to FIG. 5. FIG. 5 is a detailed flowchart of the block 410 according to an embodiment of the present invention.

As shown in a process 500 in FIG. 5, first at block 505, in the main memory of the multiprocessor system, a plurality of memory area corresponding in number to the plurality of cells in the simulated substance space are set, wherein, each memory area is used for storing data of molecules of one of the plurality of cells.

More specifically, in the case where as described at the block 405, the simulated substance space is divided into M×M×M cubic cells, at this block 505, M×M×M memory areas are set in the main memory of the multiprocessor system, so as to store data of molecules of the M×M×M cells, respectively.

In addition, in a preferred embodiment, at this block, the plurality of memory areas are set continuously in the main memory.

In addition, since as mentioned earlier, molecules are in constant motion and one molecule may move from one cell to another cell, the number of molecules in a cell also changes accordingly. For this reason, at this block, each of the plurality of memory areas is set to be large enough, so that even if the number of molecules in the corresponding cell changes, the memory area is capable of storing all the data of molecules in the cell entirely. More specifically, first, the maximum possible number of molecules in a cell may be preset, and then, the size of each of the plurality of memory areas is set based on the maximum possible number of molecules. In addition, preferably, the plurality of memory areas have the same size.

At block 510, correspondence relationship between the plurality of cells and the plurality of memory areas is determined.

In an embodiment, relative position coordinates may be set for the plurality of cells in the space coordinates system, and the correspondence relationship between the plurality of cells and the plurality of memory areas is determined based on the relative position coordinates.

More specifically, referring to FIG. 1, the relative position coordinates for the cell in the simulated substance space that is located at the origin of the space coordinates system are set to (x=0, y=0, z=0), and the x coordinates for the cells along the positive direction of the x-axis increase progressively in turn, for example, the coordinates for the second cell in the positive direction of the x-axis are set to (x=1, y=0, z=0), and the rest may be deduced by analogy. In addition, the y coordinates for the cells along the positive direction of the y-axis increase progressively in turn, for example, the coordinates for the second cell in the positive direction of the y-axis are set to (x=0, y=1, z=0), and the rest may be deduced by analogy. Furthermore, the z coordinates for the cells along the positive direction of the z-axis increase progressively in turn, for example, the coordinates for the second cell in the positive direction of the z-axis are set to (x=0, y=0, z=1), and the rest may be deduced by analogy.

Then, on the basis of the relative position coordinates, and in the case where as mentioned earlier, the simulated substance space is divided into M×M×M cubic cells, correspondence between the cell whose coordinates are (x, y, z) and the corresponding memory area in the plurality of memory areas is established according to the following equation (1):

Index=x+M×y+M²×z (1),

wherein, Index denotes the sequence number of the memory area corresponding to the cell whose coordinates are (x, y, z). That is, based on Index, it can be determined that the memory area corresponding to the cell whose coordinates are (x, y, z) is the Indexth memory area among the plurality of (in this case, M×M×M) memory areas that starts from the initial address.

More specifically, referring to FIG. 1, it is assumed that the simulated substance space is divided into 3×3×3 (i.e. M=3) cubic cells, then the relative position coordinates for the cell that is located at the origin of the space coordinates system can be determined as (x=0, y=0, z=0), and according to the above equation (1), it can be determined that the sequence number of the memory area corresponding to this cell is Index=x+M×y+M²×z=0+3×0+3²×0=0. In addition, the coordinates for the second cell that is next to the cell at the origin in the positive direction of the x-axis can be set to (x=1, y=0, z=0), and according to the above equation (1), it can be determined that the sequence number of the memory area corresponding to this cell is Index=x+M×y+M²×z=1+3×0+3²×0=1, and the rest may be deduced by analogy. In addition, the coordinates for the second cell that is in the positive direction of the y-axis can be set to (x=0, y=1, z=0), and according to the above equation (1), it can be determined that the sequence number of the memory area corresponding to this cell is Index=x+M×y+M²×z=0+3×1+3²×0=3, and the rest may be deduced by analogy. Furthermore, the coordinates for the second cell that is in the positive direction of the z-axis can be set to (x=0, y=0, z=1), and according to the above equation (1), it can be determined that the sequence number of the memory area corresponding to this cell is Index=x+M×y+M²×z=0+3×0+3²×1=9, and the rest may be deduced by analogy.

In addition, based on the relative position coordinates for the cells in the space coordinates system, the adjacency relationship between the respective cells can also be determined. For example, it can be determined that the cell whose coordinates are (x=1, y=0, z=0) is the adjacent cell on the right side of the cell whose coordinates are (x=0, y=0, z=0), and the cell whose coordinates are (x=0, y=1, z=0) is the adjacent cell right above the cell whose coordinates are (x=0, y=0, z=0).

The above correspondence relationship between the cells and memory areas, and the adjacency relationship between the cells, are to be applied to the process in which the respective accelerators acquire a plurality of relevant cells so as to perform molecular dynamics simulation computations. Therefore, if these relationships can be directly determined based on the coordinates of the cells, a great convenience will be offered to the respective accelerators.

Although it is described hereinabove that the relative position coordinates for the cells are utilized to determine the correspondence relationship between the cells and memory areas, the present invention is not limited to this, and corresponding numbers may be directly set for the plurality of cells and the plurality of memory areas, so as to establish one-to-one correspondence between the plurality of cells and the plurality of memory areas according to the numbers.

At block 515, based on the correspondence relationship between the plurality of cells and the plurality of memory areas, data of molecules of the plurality of cells are stored in the respective corresponding memory areas among the plurality of memory areas, respectively, wherein, data of molecules of each cell is continuously stored in the memory area corresponding to the cell.

In addition, in an embodiment, at the beginning of each of the plurality of memory areas, the amount of data of molecules stored in the memory area, namely the number of molecules in the cell corresponding to the memory area, is indicated, so as to facilitate the access of a corresponding accelerator among the plurality of accelerators to the data in the memory area.

The above is a detailed description of the molecule data storing process as shown in FIG. 5.

Next, the block 415 of acquiring the data of molecules and performing molecular dynamics simulation computation of the method as shown in FIG. 4 is described in detail with reference to FIGS. 6 and 7. FIG. 6 is a detailed flowchart 600 of the block 415 according to an embodiment of the present invention, and FIGS. 7 and 8 are illustrations of the process as shown in FIG. 6.

As shown in FIG. 6, first at block 605, based on the number of the plurality of accelerators, the plurality of cells are divided into a plurality of corresponding parts, wherein each part comprises multiple layers of cells.

More specifically, as shown in a diagram 650 in FIG. 7, at this block, the plurality of cells are divided into a plurality of parts along the z-axis direction of the space coordinates system.

In addition, in an embodiment, according to the rule of load balancing, the plurality of cells are divided into a plurality of equal parts. That is, in the case where as mentioned hereinabove, the simulated substance space is divided into M×M×M cells and the number of the accelerators is m, the plurality of cells are divided along the z-axis into a plurality of parts corresponding to the accelerators in number, each part comprising M/m layers of cells.

It should be noted that although dividing is carried out along the z-axis direction in FIG. 7, the manner of dividing is not limited to this. For example, the plurality of cells may be divided along the x-axis or y-axis into a plurality of parts corresponding to the accelerators in number.

At block 610, as shown in FIG. 7, the plurality of parts are assigned to the plurality of accelerators, so that each accelerator is responsible for processing one part thereamong.

At block 615, the plurality of accelerators, for their respective parts, acquire data of molecules and perform molecular dynamics simulation computations layer by layer in parallel in the manner that data of molecules of at least one cell are acquired in one DMA operation, wherein the plurality of accelerators are spaced apart from each other by multiple layers of cells throughout the parallel processing.

As mentioned earlier, since molecules are in constant motion, and one molecule may move from one cell to another cell, it is necessary to adjust the subordination relationship between the molecules and the cells after each iterative computation step. In the present embodiment, as mentioned earlier, data of molecules of each cell are continuously stored in a memory area corresponding to the cell, therefore, adjustment of the subordination relationship between molecules and cells can be realized by directly moving data of molecules between the memory areas corresponding to the respective cells.

However, in the case where molecular dynamics simulation is performed in parallel on a plurality of accelerators, if cells on two different accelerators are too close to each other within the simulated substance space, then as shown in FIG. 8, it is likely that molecules in these cells move into the same destination cell, and accordingly, the two accelerators, in this example a SPU_1 802 and a SPU_2 804, need to simultaneously use data of molecules in a destination cell 806 to perform adjustments after the simulation computations. As a result, a data collision will be generated.

In the present embodiment, through dividing the plurality of cells into the plurality of parts each comprises multiple layers of cells and spacing the respective accelerators apart from each other by multiple layers of cells throughout the parallel processing, the data collision that is likely to be generated when the subordination relationships between molecules and cells are adjusted can be avoided.

More specifically, in the present embodiment, as shown by FIG. 7, in the case where a plurality of cells are divided along the z-axis direction of the space coordinates system into a plurality of parts, in order that the respective accelerators are spaced apart from each other by multiple layers of cells during the parallel processing, the respective accelerators, for their respective parts, may acquire data of molecules and perform molecular dynamics simulation computations layer by layer in the same layer sequence, such as from the bottom up or from the top down along the z-axis.

In this manner, when the plurality of accelerators acquire data of molecules of their respective first layers of cells, these first layers are spaced apart from each other by multiple layers of cells, and accordingly, since the plurality of accelerators perform parallel processing in the same layer sequence, the spacing state can be maintained, i.e. the current layers processed in parallel by the respective accelerators are always spaced apart from each other by multiple layers of cells.

Accordingly, the case where two cells located on different accelerators are too close to each other within the substance space, thus giving rise to a data collision can be avoided.

In addition, in the case where another manner of dividing is adopted, such as dividing the plurality of cells into a plurality of parts along the x-axis or y-axis, the present invention can also be realized according to the above.

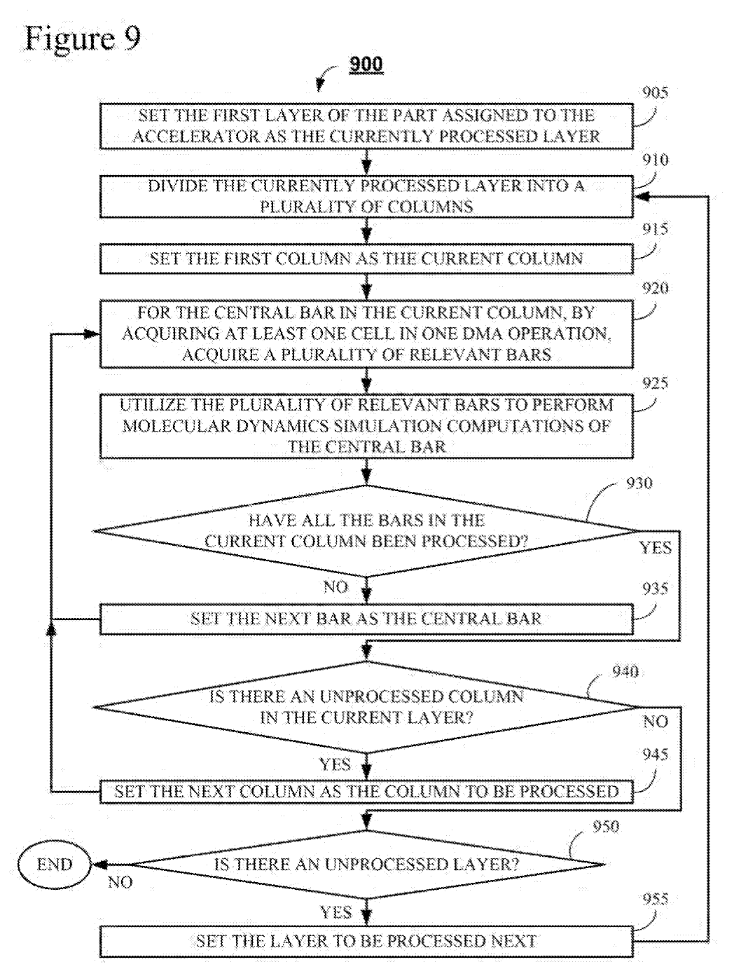

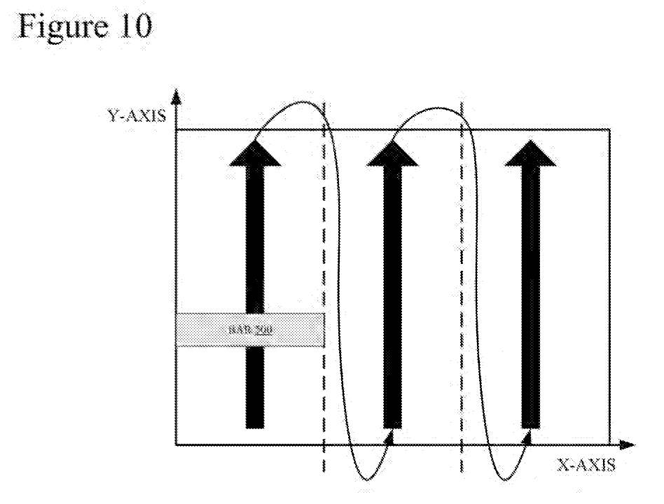

Next, the block 615 of acquiring data of molecules and performing molecular dynamics simulation layer-by-layer in FIG. 6 is described in detail with reference to FIGS. 9-12. FIG. 9 is a detailed flowchart of the block 615 according to an embodiment of the present invention, which takes one accelerator as an example, and FIGS. 10-12 are illustrations of the process as shown in FIG. 9.

It should be noted that as described earlier with respect to the linkcell method, when simulation computations such as calculation of acting force between molecules are performed on molecules in a certain central cell, data of molecules in the central cell itself and 13 surrounding adjacent cells, in total 14 cells, need to be taken into account, and thus acquired.

In contrast with this, in the process as shown in FIG. 9, when simulation computations are performed on the central cell, data of molecules of the entire bars in which the 14 cells relevant to the simulation computations are located respectively, instead of merely the 14 individual cells, are acquired. That is, in the process as shown in FIG. 9, bar is regarded as the unit, so that data of molecules are acquire and molecular dynamics simulation computations are performed bar by bar within each layer.

More specifically, as shown in a process 900 in FIG. 9, first at block 905, among the plurality of parts obtained by dividing the plurality of cells, the first layer of the part assigned to the current accelerator is set as the currently processed layer, wherein, the bottommost layer of the part in the positive direction of the z-axis may be set as the first layer, so that the accelerator performs processing layer by layer along the positive direction of the z-axis, or, the topmost layer in the positive direction of the z-axis may be set as the first layer, so that the accelerator performs processing layer by layer along the negative direction of the z-axis.

At a block 910, the currently processed layer is divided into a plurality of columns.

More specifically, referring to FIG. 10, at this block, the currently processed layer is divided into a plurality of columns along the x-axis of the space coordinates system.

At this block, dividing of the currently processed layer into a plurality of columns is based on the consideration that in a multiprocessor system, the size of the local storage of an accelerator is generally limited. For example, in CBE 130, the capacity of the local storage 161-168 of each SPU 141-148 is 256K only. In such a case, since one layer of cells in the simulated substance space generally comprise a large amount of molecule data and the capacity of the local storage of each accelerator is generally far from enough, it is necessary to acquire in sequence a part of the data of molecules in the layer to perform processing.

Accordingly, in the present embodiment, the currently processed layer is divided into a plurality of columns along the x-axis, so that as shown in FIG. 9, processing of the data of molecules is performed column by column, wherein the column length of the plurality of columns, namely the number of the cells in a column along the x-axis direction, is determined based on the of the local storage of an accelerator in the multiprocessor system and the number of molecules comprised within a cell.

At a block 915, the first column in the currently processed layer is set as the current column.

At a block 920, for a bar (hereinafter referred to as the central bar) on which molecular dynamics simulation computations are to be performed in the current column, the accelerator acquires data of molecules of a plurality of bars relevant to the molecular dynamics simulation computations of the central bar into its local storage in the manner in which data of molecules of at least one cell are acquired in one DMA operation, wherein, as shown in FIGS. 9 and 10, the so-called one bar is a row of cells in a column along the x-axis direction.

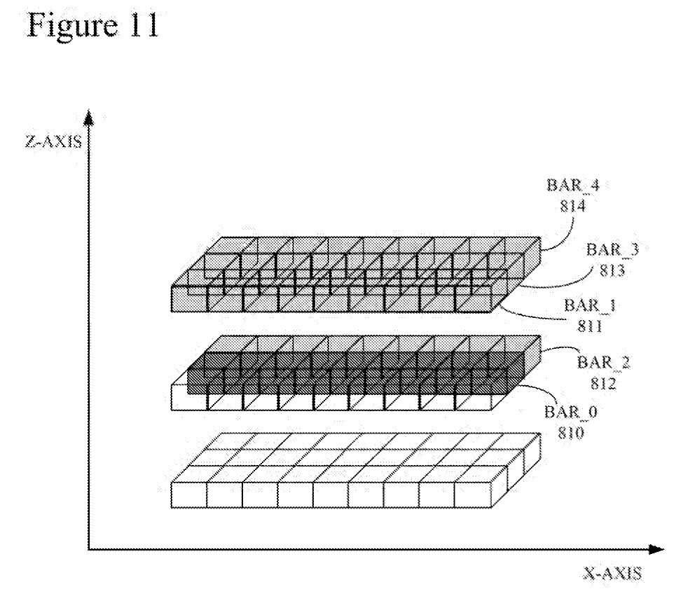

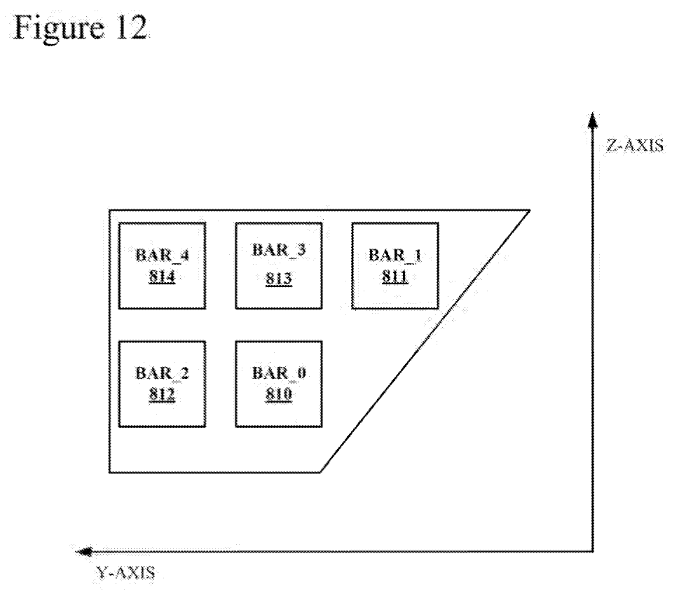

More specifically, as shown in FIGS. 11 and 12, it is assumed that the central cell on which simulation computations are to be performed currently is located in a bar_0 810. Then, since the 13 adjacent cells relevant to the simulation computations of the central cell, further located above the central cell or at the lateral side of the central cell, are in bars_1-4 811-814 located above the bar_0 810 or at the lateral side of bar_0 810, respectively, the accelerator acquires the whole bars 801-804 and the whole bar_0 810 (or central bar) together into its local storage in the present embodiment.

Accordingly, it can be appreciated that in the case where the first bar in the current column serves as the central bar on which molecular dynamics simulation computations are to be performed, it is required that the accelerator acquires data of molecules of the central bar itself, the next bar of the bar and the 3 adjacent bars above the bar, in total 5 bars, into the local storage thereof. In addition, it can be appreciated by a person skilled in the art that since the first bar is located on the boundary of the current layer, as one of the three adjacent bars above the bar, the bar on the upper layer of the central bar and at the other side opposite to the side on which the central bar is located is used. Moreover, as to all the similar boundary problems existing in simulation computations, the similar dealing manner is adopted.

In addition, in the case where the central bar on which molecular dynamics simulation computations are to be performed is not the first bar in the current column, it is not necessary that the accelerator reacquires data of molecules of all the 5 bars relevant to the molecular dynamics simulation computations of the central bar into its local storage. Since some bars among the 5 bars have been stored in the local storage of the accelerator during the molecular dynamics simulation computations of the preceding bar, only the bars among the 5 bars that have not been stored in the local storage of the accelerator are needed to be acquired, i.e. only the next adjacent bar of the central bar, and the next bar above the central bar are needed to be acquired.

In addition, in the present embodiment, since data of molecules within each cell are continuously stored in the memory area corresponding to the cell, all the data of molecules in the cell can be acquired into the local storage of the accelerator in one DMA operation. Accordingly, at this block, the accelerator may acquire a plurality of required bars in the manner in which one cell is acquired in one DMA operation.

Further, in the case where as described at block 505 in FIG. 5, the memory areas corresponding to the plurality of cells in the simulated substance space are continuously set in the main memory, i.e. the plurality of cells are continuously stored in the main memory, data of molecules of a plurality of cells that are adjacent thereto can be acquired by utilizing one DMA operation. Accordingly, at this block, the accelerator may acquire a plurality of required bars in the manner in which a plurality of cells are acquired in one DMA operation.

Furthermore, in the case where as described at block 510 in FIG. 5, relative position coordinates are set for the cells in the simulated substance space and the respective cells are corresponded to their memory areas by utilizing the relative position coordinates, owing to the fact that the memory areas corresponding to a row of cells in the a-axis direction are continuous, one DMA operation can be utilized to acquire all data of molecules of the row of cells, or of a part of the row of cells, namely a bar, into the local storage of the accelerator. Accordingly, at this block, the accelerator may acquire a plurality of required bars in the manner in which a bar constituted by a plurality of cells is acquired in one DMA operation. In this process, based on the relative position coordinates of the cells, relevant bars that are located above the central bar or at the lateral side of the central bar, are located, and further acquired the data of molecules.

Further, at this block, based on the determined correspondence relationship between the plurality of cells and the plurality of memory areas, the accelerator acquires data of molecules of the plurality of bars.

Next, at a block 925, the accelerator utilizes the data of molecules of the plurality of bars stored in its local storage to perform molecular dynamics simulation computations of the data of molecules of the central bar. At this block, the data of molecules of the plurality of bars are utilized to accomplish molecular dynamics simulation computations of all the cells in the central bar. That is, for all the cells in the central bar, molecular dynamics simulation computations are performed by utilizing in turn data of molecules of the relevant cells in the plurality of bars.

At a block 930, it is determined whether all the bars in the current column have undergone molecular dynamics simulation computations. If so, the process turns to a block 940; otherwise, proceeds to a block 935.

At block 935, the next bar of the central bar in the current column is set as the central bar on which molecular dynamics simulation computations are to be performed, then the process returns to block 920, to process the next bar.

At block 940, it is determined whether there is a column in the current layer that has not been processed. If so, the process proceeds to a block 945; otherwise, turns to a block 950.

At block 945, the next column of the current column is set as the column to be processed, then the process returns to block 920, to process the next column.

At block 950, it is determined whether there is a layer in the part assigned to the accelerator that has not been processed. If so, the process proceeds to a block 955; otherwise, the process ends.

At block 955, the layer to be processed next is set. In the case where each accelerator processes the part assigned thereto upwardly layer by layer from the bottommost layer in the z-axis direction, the layer above the currently processed layer is set as the layer to be processed next, and in the case where the part is processed downwardly layer by layer from the topmost layer, the layer below the currently processed layer is set as the layer to be processed next.

Next, the process returns to block 910, to process the next layer.

The above is a detailed description of the process of acquiring data of molecules and performing simulation computation layer-by-layer in FIG. 9.

It should be noted that although the process in FIG. 9 comprises dividing the currently processed layer into a plurality of columns, it can be appreciated that this process is performed by taking into account the limited capacity of the local storage of the accelerator. Therefore, in the case where the capacity of the local storage of each accelerator permits, this process may not be performed, i.e. the currently processed layer is processed as a whole, instead of being divided into a plurality of columns.

In addition, in the process in FIG. 9, although the present invention is described with reference to the case where the currently processed layer is divided into a plurality of columns along the x-axis of the space coordinates system, it is not limited to this, and another manner of dividing may be adopted, such as dividing the currently processed layer into a plurality of columns along the y-axis of the space coordinates system, or the like.

In addition, in the process in FIG. 9, although the present invention is described with reference to the case where each accelerator acquires data of molecules of a plurality of bars when performing simulation computations, the present invention is not limited to this, and it also may be that as the prior art, for molecular dynamics simulation computations of the central cell, the accelerator only acquires data of molecules of the 14 cells relevant to the simulation computations.

The above is a detailed description of the method for performing molecular dynamics simulation on a multiprocessor system of the present embodiment. In the present embodiment, by continuously storing data of molecules of each cell in the simulated substance space in a memory area corresponding to the cell, each accelerator can utilize less DMA operations to acquire data of molecules of a plurality of cells from the main memory into its local storage, thereby the frequent data exchanges between the accelerator and the main memory are reduced. Further, by continuously storing the plurality of cells in the simulated substance space based on position relationships, each accelerator can acquire data of molecules of a bar constituted by a plurality of cells into its local storage in one DMA operation, whereby molecular dynamics simulation is performed in term of bar, thereby the data exchanges between the accelerator and the main memory are further reduced. Accordingly, as compared with the abovementioned existing solutions of molecular dynamics simulation, the molecular dynamics simulation method of the present embodiment can increase the ratio of time spent on calculation versus the time spent on data transfer, thereby enhancing simulation performance.

Under the same inventive concept, the present invention provides an apparatus for performing molecular dynamics simulation in a multiprocessor system, which will be described as follows with reference to the figures.

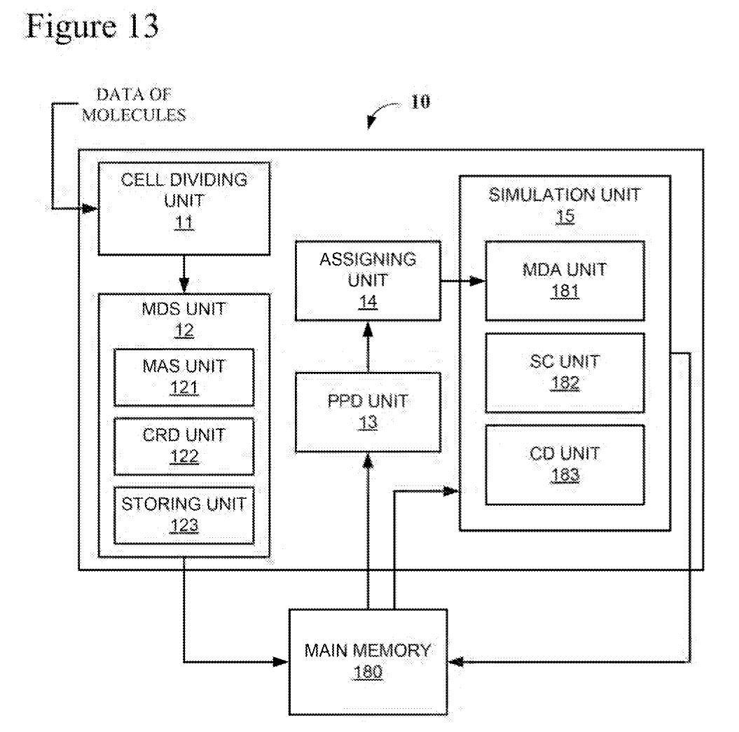

FIG. 13 is a block diagram of the apparatus for performing molecular dynamics simulation in a multiprocessor system according to an embodiment of the present invention, wherein the multiprocessor system comprises at least one core processor and a plurality of accelerators. More specifically, the multiprocessor system can be, for example, the abovementioned CBE 130 that has one PPU (core processor) 171 and eight SPUs (accelerators) 141-148.

More specifically, as shown in FIG. 13, the apparatus 10 for performing molecular dynamics simulation in a multiprocessor system of the present embodiment comprises a cell dividing unit 11, a molecular data storing unit 12, a plural part dividing unit 13, an assigning unit 14 and a simulation unit 15.

Cell dividing unit 11 divides a substance space on which molecular dynamics simulation needs to be performed into a plurality of cubic cells. Molecular data storing unit 12 stores data of molecules of the plurality of cells in the main memory of the multiprocessor system in the manner in which data of molecules of each cell are continuously stored in a memory area corresponding to the cell.

As shown in FIG. 13 molecular data storing unit 12 further comprises a memory area setting unit 121, a correspondence relationship determining unit 122, and a storing unit 123.

Memory area setting unit 121 sets a plurality of memory areas corresponding in number to the plurality of cells in the main memory of the multiprocessor system. In a preferred embodiment, the memory area setting unit 121 continuously sets the plurality of memory areas in the main memory.

The correspondence relationship determining unit 122 determines the correspondence relationship between the plurality of cells and the plurality of memory areas. In a preferred embodiment, the correspondence relationship determining unit 122 sets for the plurality of cells relative position coordinates in the space coordinates system, and by means of calculation of the relative position coordinates, determines the correspondence relationship between the plurality of cells and the plurality of memory areas.

The storing unit 123 stores data of molecules of the plurality of cells in the plurality of memory areas respectively based on the correspondence relationship between the plurality of cells and the plurality of memory areas in the manner in which data of molecules of each cell are continuously stored in a memory area corresponding to the cell.

The plural part dividing unit 13 divides the plurality of cells into a plurality of corresponding parts based on the number of the plurality of accelerators, wherein each part comprises multiple layers of cells.

Assigning unit 14 assigns the plurality of parts to the plurality of accelerators, so that each accelerator processes one part thereamong.

Simulation unit 15 enables the plurality of accelerators to repeatedly acquire the data of molecules of the plurality of cells from the main memory and perform molecular dynamics simulation computations in parallel in the manner in which data of molecules of at least one cell are acquired in one DMA operation.

More specifically, simulation unit 15 enables the plurality of accelerators, for their respective parts, to acquire data of molecules and perform molecular dynamics simulation computations layer by layer in parallel in the manner in which data of molecules of at least one cell are acquired in one DMA operation, wherein the plurality of accelerators are spaced apart from each other by multiple layers of cells throughout the parallel processing. Further, simulation unit 15 enables the plurality of accelerators, for their respective parts, to acquire data of molecules and perform molecular dynamics simulation computations bar by bar within each layer in parallel, wherein one bar comprises a plurality of cells.

As shown in FIG. 13, simulation unit 15 further comprises a molecular data acquiring unit 181 and a simulation computation unit 182.

Molecular data acquiring unit 181 enables the plurality of accelerators, for their respective parts, and layer by layer from the first layer: for the respective bars in the current layer, to acquire data of molecules of a plurality of bars relevant to the molecular dynamics simulation computations of the current bar into the local storages in parallel in the manner in which data of molecules of at least one cell are acquired in one DMA operation. In addition, molecular data acquiring unit 181 enables the plurality of accelerators to acquire data of molecules of their respective plurality of bars based on the determined correspondence relationship between the plurality of cells and the plurality of memory areas, respectively.

Simulation computation unit 182 enables the plurality of accelerators to utilize the data of molecules of the plurality of bars stored in their respective local storages to perform molecular dynamics simulation computations in parallel.

In an embodiment, Simulation unit 15 also comprises an optional column dividing unit 183 which divides the currently processed layer into a plurality of columns for each of the plurality of accelerators based on the capacity of the local storages of the plurality of accelerators and the number of molecules in each of the plurality of cells.

In such a case, molecular data acquiring unit 181 and simulation computation unit 182 enable the plurality of accelerators, for their respective current bars in each of the plurality of columns, to acquire data of molecules of a plurality of bars relevant to the molecular dynamics simulation computations of the current bars into the local storages and utilize the data of molecules of the plurality of bars to perform molecular dynamics simulation computations of the current bars in parallel in the manner in which data of molecules of at least one cell are acquired in one DMA operation.

In one embodiment, the memory areas corresponding to the respective cells in each bar are continuously set in the main memory.

In such a case, simulation unit 15 enables the plurality of accelerators, for their respective parts, to acquire data of molecules and perform molecular dynamics simulation computations bar by bar within each layer in parallel in the manner in which data of molecules of one bar are acquired in one DMA operation.

The above is a detailed description of the apparatus for performing molecular dynamics simulation in a multiprocessor system of the present embodiment. Herein, apparatus 10 and the components thereof can be implemented with specifically designed circuits or chips or be implemented by a computer (processor) executing corresponding programs.

The present invention also provides a program product, which comprises program codes for implementing all the above methods on a multiprocessor system, and a bearing media that bearing the program codes.

While the method and apparatus for performing molecular dynamics simulation on a multiprocessor system of, the present invention have been described in detail with some exemplary embodiments, these embodiments are not exhaustive, and those skilled in the art may make various variations and modifications within the spirit and scope of the present invention. Therefore, the present invention is not limited to these embodiments, the scope of which is only defined by appended claims.

1. A method, comprising:
dividing a simulated substance space on which a molecular dynamics simulation is to be performed into a plurality of cells, each cell corresponding to a molecule of a plurality of molecules;
storing data corresponding to the plurality of cells in a main memory of a multiprocessor system such that data corresponding to each particular cell of the plurality of cells is continuously stored in a memory area of a plurality of memory areas corresponding to the particular cell;
repeatedly acquiring the data corresponding to the plurality of cells from the main memory such that the data corresponding to each particular cell is acquired in a single direct memory access (DMA) operation; and
performing, on a plurality of accelerators associated with the multiprocessor system, molecular dynamics simulation computations in parallel on the acquired data.

2. The method of claim 1, wherein the storing data corresponding to the plurality of cells comprises:
setting the plurality of memory areas corresponding in number to the plurality of cells in the main memory of the multiprocessor system;
determining a correspondence relationship between the plurality of cells and the plurality of memory areas; and
storing data of the plurality of cells in the plurality of memory areas based on the correspondence relationship between the plurality of cells and the plurality of memory areas.

3. The method of claim 2, wherein the plurality of memory areas are continuously set in the main memory.

4. The method of claim 2, wherein the determining the correspondence relationship between the plurality of cells and the plurality of memory areas comprises:
setting coordinates in a space coordinates system for each of the plurality of cells based upon relative positions of the plurality of cells; and
determining the correspondence relationship between the plurality of cells and the plurality of memory areas based upon the coordinates.

5. The method of claim 1, wherein the repeatedly acquiring the data of the plurality of cells comprises:
dividing the plurality of cells into a plurality of corresponding layers based on the number of the plurality of accelerators, wherein each layer comprises multiple bars of cells;
assigning the plurality of layers to the plurality of accelerators, so that each accelerator processes one layer; and
the plurality of accelerators, for their respective parts, acquiring the data of the plurality of cells and performing molecular dynamics simulation computations bar by bar in parallel, such that the layers are spaced apart from each other, throughout the parallel processing.

6. The method of claim 5, wherein the plurality of corresponding layers correspond to layers along a coordinate axis direction of a space coordinates system.

7. The method of claim 5, wherein each layer comprises a specific subset of the plurality of cells.

8. The method as recited in claim 7, wherein the plurality of accelerators, for their respective parts, acquiring data of molecules and performing molecular dynamics simulation computations bar by bar within each layer in parallel comprises:
for the respective current bars in the current layer, acquiring data of molecules of a plurality of parts relevant to the molecular dynamics simulation computations of the current parts into the local storages; and
utilizing the data of molecules of the plurality of parts to perform molecular dynamics simulation computations of the current parts in parallel.

9. The method of claim 7, wherein the plurality of accelerators, for their respective parts, acquiring data of molecules and performing molecular dynamics simulation computations bar by bar within each layer in parallel further comprises:
layer by layer from the first layer, dividing the current layer into a plurality of columns based on the capacity of the local storages of the plurality of accelerators and the number of molecules in each of the plurality of cells; and
for the respective current bars in each of the plurality of columns, acquiring data of molecules of a plurality of bars relevant to the molecular dynamics simulation computations of the current bars into the local storages, and utilizing the data of molecules of the plurality of bars to perform molecular dynamics simulation computations of the current bars in parallel.

10. The method of claim 7, wherein the memory areas corresponding to the respective cells in each bar are continuously set in the main memory; and
the plurality of accelerators, for their respective parts, acquiring data of molecules and performing molecular dynamics simulation computations bar by bar within each layer in parallel further comprises acquiring data of molecules and performing molecular dynamics simulation computations bar by bar within each layer in parallel in the manner in which data of molecules of one bar are acquired in one DMA operation.

11. An apparatus for performing molecular dynamics simulation in a multiprocessor system, wherein the multiprocessor system comprises at least one core processor and a plurality of accelerators, the apparatus comprising:
a cell dividing unit for dividing a substance space on which molecular dynamics simulation are to be performed into a plurality of cells;
a molecular data storing unit for storing data of molecules of the plurality of cells in a main memory of the multiprocessor system in the manner in which data of molecules of each cell are continuously stored in a memory area corresponding to the cell; and
a simulation unit for enabling the plurality of accelerators to repeatedly acquire the data of molecules of the plurality of cells from the main memory and perform molecular dynamics simulation computations in parallel in the manner in which data of molecules of at least one cell are acquired in one direct memory access (DMA) operation.

12. The apparatus of claim 11, wherein the molecular data storing unit further comprises:
a memory area setting unit for setting a plurality of memory areas corresponding in number to the plurality of cells in the main memory of the multiprocessor system;
a correspondence relationship determining unit for determining the correspondence relationship between the plurality of cells and the plurality of memory areas; and
a storing unit for storing data of molecules of the plurality of cells in the plurality of memory areas respectively based on the correspondence relationship between the plurality of cells and the plurality of memory areas in the manner in which data of molecules of each cell are continuously stored in a memory area corresponding to the cell.

13. The apparatus as recited in claim 12, wherein the plurality of memory areas are continuously set in the main memory.

14. The apparatus of claim 11, further comprising:
a plural part dividing unit for, based on the number of the plurality of accelerators, dividing the plurality of cells into a plurality of corresponding bars, wherein each layer comprises multiple bars of cells; and
an assigning unit for assigning the plurality of layers to the plurality of accelerators, so that each accelerator processes one layer thereamong;
wherein, the simulation unit enables the plurality of accelerators, for their respective parts, to acquire data of molecules and perform molecular dynamics simulation computations bar by bar in parallel, wherein the plurality of accelerators are spaced apart from each other by multiple layers of cells throughout the parallel processing.

15. The apparatus of claim 14, wherein the simulation unit further enables the plurality of accelerators, for their respective layers, to acquire data of molecules and perform molecular dynamics simulation computations bar by bar within each layer in parallel, wherein one layer comprises a plurality of bars.

16. The apparatus of claim 15, wherein the simulation unit further comprises:
a molecular data acquiring unit for enabling the plurality of accelerators, for their respective layers, and bar by bar from the first layer, for the respective current bars in the current layer, to acquire data of molecules of a plurality of bars relevant to the molecular dynamics simulation computations of the current bars into the local storages in parallel in the manner in which data of molecules of at least one cell are acquired in one DMA operation; and
a simulation computation unit for enabling the plurality of accelerators to utilize the data of molecules of the plurality of bars stored in their local storages to perform molecular dynamics simulation computations of the current bars in parallel.

17. The apparatus of claim 16, wherein the simulation unit further comprises:
a column dividing unit for, for each of the plurality of accelerators, dividing the currently processed layer into a plurality of columns based on the capacity of the local storages of the plurality of accelerators and the number of molecules in each of the plurality of cells;
wherein the molecular data acquiring unit and the simulation computation unit enable the plurality of accelerators, for the respective current bars in each of the plurality of columns, to acquire data of molecules of a plurality of bars relevant to the molecular dynamics simulation computations of the current bars into the local storages, and utilize the data of molecules of the plurality of bars to perform molecular dynamics simulation computations of the current bars in parallel.

18. The apparatus of claim 15, wherein the memory areas corresponding to the respective cells in each bar are continuously set in the main memory; and
the simulation unit enables the plurality of accelerators, for their respective bars, to acquire data of cells and perform molecular dynamics simulation computations bar by bar within each layer in parallel in the manner in which data of molecules of one bar are acquired in one DMA operation.

19. A computer programming product, comprising:
a computer-readable, physical memory;
logic, stored on the computer-readable, physical memory for execution on a processor, for:
dividing a simulated substance space on which a molecular dynamics simulation is to be performed into a plurality of cells, each cell corresponding to a molecule of a plurality of molecules;
storing data corresponding to the plurality of cells in a main memory of a multiprocessor system such that data corresponding to each particular cell of the plurality of cells is continuously stored in a memory area of a plurality of memory areas corresponding to the particular cell;
repeatedly acquiring the data corresponding to the plurality of cells from the main memory such that the data corresponding to each particular cell is acquired in a single direct memory access (DMA) operation; and
performing, on a plurality of accelerators associated with the multiprocessor system, molecular dynamics simulation computations in parallel on the acquired data.

20. The computer programming product of claim 1, wherein the logic for storing data corresponding to the plurality of cells comprises logic for:
setting the plurality of memory areas corresponding in number to the plurality of cells in the main memory of the multiprocessor system;
determining a correspondence relationship between the plurality of cells and the plurality of memory areas; and
storing data of the plurality of cells in the plurality of memory areas based on the correspondence relationship between the plurality of cells and the plurality of memory areas.

21. The computer programming product of claim 20, wherein the plurality of memory areas are continuously set in the main memory.

22. The computer programming product of claim 20, wherein the logic for determining the correspondence relationship between the plurality of cells and the plurality of memory areas comprises logic for:
setting coordinates in a space coordinates system for each of the plurality of cells based upon relative positions of the plurality of cells; and
determining the correspondence relationship between the plurality of cells and the plurality of memory areas based upon the coordinates.

23. The computer programming product of claim 19, wherein the logic for repeatedly acquiring the data of the plurality of cells comprises logic for:
dividing the plurality of cells into a plurality of corresponding layers based on the number of the plurality of accelerators, wherein each layer comprises multiple bars of cells;
assigning the plurality of layers to the plurality of accelerators, so that each accelerator processes one layer; and
the plurality of accelerators, for their respective parts, acquiring the data of the plurality of cells and performing molecular dynamics simulation computations bar by bar in parallel, such that the layers are spaced apart from each other, throughout the parallel processing.

24. The computer programming product of claim 23, wherein the plurality of corresponding layers correspond to layers along a coordinate axis direction of a space coordinates system.

25. The computer programming product of claim 23, wherein each layer comprises a specific subset of the plurality of cells.
